(19) United States
(12) Patent Application Publication
(10) Pub. No.: US 2025/0344706 A1
(43) Pub. Date: Nov. 13, 2025

(54) LOWER CALORIE BAKED PRODUCTS

(71) Applicant: Intercontinental Great Brands LLC, East Hanover, NJ (US)

(72) Inventors: Katelyn Comerford, East Hanover, NJ (US); Indraneil Mukherjee, East Hanover, NJ (US); Clive Norton, East Hanover, NJ (US)

(21) Appl. No.: 18/871,134

(22) PCT Filed: Jun. 1, 2023
(86) PCT No.: PCT/US2023/024147

§ 371 Date: Dec. 2, 2024

Related U.S. Application Data
(60) Provisional application No. 63/350,814, filed on Jun. 9, 2022.

(30) Foreign Application Priority Data
Aug. 12, 2022 (GB) 2211832.7

(51) Int. Cl. A21D 13/06; A21D 13/24; A21D 13/30

(52) U.S. Cl. CPC A21D 13/06; A21D 13/24; A21D 13/30

(57) ABSTRACT

The present invention relates to baked products having an energy content of no more than 1670 KJ per 100 g, the product comprising: 1.0 to 20 g per 100 g total dietary fibre; at least 16 g per 100 g total fat; 0.05 to 4.00 g per 100 g of one or more caloric sugars; 5 to 33 g per 100 g of one or more sugar alcohols; no more than 12 g per 100 g of one or more carbohydrates having an energy content of below 0.5 kcal/gram; and 0.1 to 16 wt. % of total moisture by weight of the baked product; wherein a combined total theoretical heat of solution of the one or more sugar alcohols and/or the one or more carbohydrates having energy content below 0.5 kcal/gram is not lower than −6 j/g.

### TECHNICAL FIELD OF THE INVENTION

The present invention relates to baked products. In particular, the present invention relates to lower calorie baked products.

### BACKGROUND TO THE INVENTION

An imbalance of energy intake and energy expenditure can result in weight gain and predispose some risk factors for non-communicable diseases such as heart disease and diabetes. When looking at calorie density, Fat is the most calorie dense and therefore when lowering the calorie content of foods many formulations seek to address and replace Fats. Many food manufacturers are seeking to offer a broad choice for their consumers and innovate and reformulate lower calorie options. While low calorie fats do exist (e.g., Salatrim™, Olestra™, etc.) they also are known to have highly undesirable digestive effects.

There has been significant attention to sugar and higher energy dense foods in recent years and opportunities exist to develop lower sugar and/or lower energy containing confectionery products. This challenge especially affects sweet baked goods and confections, where sugar not only provides sweetness but also is necessary to provide an appropriate texture, colour and/or structure.

Notably, some baked goods manufacturers try to lower calories by fully or partially replacing sugars with sugar replacers such as sugar-free/calorie-free sweeteners (some of which may be artificial sweeteners such as aspartame, sucralose, etc., and some of which may be sugar alcohols (polyols)).

In baked goods, a variety of sugar replacements may be used to partially or fully replace sugar. These include non-digestible and/or digestion-resistant carbohydrates such as sugar alcohols (e.g., maltitol, erythritol, sorbitol, xylitol, etc.) and soluble fibres (e.g., digestion-resistant dextrins from sources like corn (soluble corn fibre), wheat, tapioca, etc., oligosaccharides like fructo-oligosaccharides, xylo-oligosaccharides, galacto-oligosaccharides, soy-bean oligosaccharides, human milk oligosaccharides, etc., higher molecular weight soluble fibres like gum acacia, inulin, arabinoxylans, β-glucans, etc.). However, their usage is typically restricted by local regulations due to various issues. For example, sugar alcohols may need to be declared as a separate row in the product nutrition facts column and require a laxation warning at high usage levels. On the other hand, soluble fibres may have digestive tolerance concerns only at high usage levels.

Dietary fibre may also be used to lower calories in baked products. Recent research has contributed to developing an increasingly positive perception of dietary fibre in the minds of consumers. While always considered an important dietary component for its contribution to bowel regularity, the importance of dietary fibre in maintaining healthy gut microflora leading to several desirable health outcomes has been recently discovered and the evidence base continues to build.

Dietary fibre generally refers to the indigestible portion of food derived from plants and has two components, namely, soluble dietary fibre and insoluble dietary fibre. Soluble dietary fibre dissolves in water and may be readily fermented in the colon into gases and physiologically active byproducts. On the other hand, insoluble dietary fibre does not dissolve in water and may provide a bulking effect by absorbing water as the insoluble dietary fibre moves through the digestive system.

While individuals vary greatly in terms of their sensitivity to dietary fibre, the prebiotic effect of most dietary fibres also generates gas as a by-product, which in many cases can cause undesirable gas, bloating, etc. The FDA has recently updated % Daily value (% DV) for dietary fibre at 28 g/day. Therefore, one can logically expect that the risk of such symptoms increases when the dietary fibre intake is excessive for example, exceeding the % DV.

Therefore, while food product formulators may be encouraged to incorporate small amounts of fibre for beneficial effects, products with disproportionately high total dietary fibre (TDF) values may present increased risk of digestive intolerance symptoms.

If a carbohydrate is non-digestible (or only minimally metabolized), such an ingredient would only contribute minimally to the overall energy of the product. An example of such ingredients is allulose, which been shown to provide an energy value of <0.4 KJ/g. This ingredient is generally considered to be safe for consumption at levels above 28 g/day. Such ingredients may be referred to as ‘rare sugars’, ‘non-caloric sugars’ or ‘low calorie sugars’. Erythritol is also a non-digestible carbohydrate with an energy content of 0 kcal/g. Similarly, as with erythritol, allulose is well tolerated at relatively high doses.

However, both erythritol and allulose have a high value of negative heat of solution. According to WO2008059623A1 heat of solution of allulose is −27.4 cal/g. Therefore, significant sensorial cooling can be expected from products where excessive amounts of allulose is used.

Therefore, it is clearly desirable to optimize the energy content, while keeping caloric sugars to a minimum when formulating lower caloric sugar baked products.

On the other hand, fat continuous confectionery components such as crèmes, chocolate chips, etc., are appreciated by consumers, as they provide a rich, indulgent, sensorially-pleasant mouthfeel and provide a characteristic product attribute, such as a chocolate experience to a chocolate chip cookie.

Therefore, a certain amount of fat is necessary in order for a lower caloric sugar baked product to have indulgent sensorial perception.

Due to the high calorie content of fat, it becomes even more challenging to reduce the energy content of a lower sugar baked product with a discrete fat-continuous confectionery component, especially when the confectionery component needs to comprise a significant portion of the product, such as, for example, 20% by weight or greater.

In addition to the above challenges, the ingredients that are generally known to be used for sugar replacement also bring certain challenges, as set out above. For example, sugar alcohols can be a laxative when used in high doses; dietary fibers can cause undesirable flatulence and bloating; carbohydrates with energy content below 0.5 kcal/g, such as erythritol & allulose, while well tolerated at practical usage levels, create undesirable sensorial cooling due to their highly negative heat of solution.

Therefore, it is an aim of the present invention to provide a lower-calorie baked product, which provides an indulgent mouthfeel, whilst minimizing any laxative effect, undesirable flatulence and bloating, and/or undesirable sensorial cooling.

It is a further aim of the present invention to provide a lower-calorie baked product which has a similar texture, colour and/or structure as a high-calorie baked product.

Moreover, it is an aim of the present invention to addresses at least one disadvantage of the prior art or to provide an alternative to existing baked products.

### SUMMARY OF THE INVENTION

According to a first aspect of the present invention, there is provided a baked product having an energy content of no more than 1670 KJ per 100 g, the product comprising:
1.0 to 20 g per 100 g total dietary fibre;
at least 16 g per 100 g total fat;
0.05 to 4.00 g per 100 g of one or more caloric sugars;
5 to 33 g per 100 g of one or more sugar alcohols;
no more than 12 g per 100 g of one or more carbohydrates having an energy content of below 0.5 kcal/gram; and
no more than 16 wt. % of total moisture by weight of the baked product;
wherein a combined total theoretical heat of solution of the one or more sugar alcohols and/or the one or more carbohydrates having energy content below 0.5 kcal/gram is not lower than −6 j/g.

The inventors discovered that a baked product, having the specific combination of ingredients as described in the first aspect of the invention, had a reduced calorific content, whilst still providing an indulgent mouthfeel without affecting digestion in any significant way and/or without incurring undesirable sensorial cooling.

By the term “sugar alcohol” it is meant a sugar alcohol with an energy of 0-4.5 kcal/g. The one or more sugar alcohol may be selected from the group consisting of erythritol, maltitol, mannitol, sorbitol, xylitol, arabitol, sorbitol, glycerol, hydrogenated starch hydrosylates (HSH), isomalt, lactitol, and combinations thereof.

The baked product may comprise one or more sugar alcohols in an amount of 5 to 33, 6 to 33, 8 to 33, 10 to 33, 12 to 33, 14 to 33, 16 to 33, 18 to 33, 20 to 33, 21 to 33, 22 to 33, 23 to 33, 24 to 32, 25 to 31, 25 to 30, 25 to 29, or 26 to 28 g per 100 g of the baked product.

A baked product comprising one or more sugar alcohols in the above amounts provides a baked product having a reduced calorific content, whilst still having an appropriate sweetness and not providing a laxative effect, and whilst maintaining sufficient structure, function and texture of the product.

The one or more carbohydrates having an energy content of below 0.5 kcal/g may be selected from the group consisting of erythritol and allulose. For the purposes of this invention, other carbohydrates which have not been assigned a calorie value, but which may be considered to have an energy content of below 0.5 kcal/g include sorbose, allose, altrose, gulose, iodose, talose, and combinations thereof, unless subsequently found to contain greater than 0.5 kcal/g.

The baked product may comprise one or more carbohydrates having an energy content of below 0.5 kcal/g in an amount of from 0 to 12, 1 to 12, 2 to 12, 3 to 12, 4 to 12, 5 to 11, 6 to 10, 7 to 9, 5 to 12, 6 to 12, 7 to 12, 8 to 12, 5 to 11, 5 to 10, 5 to 9, or 5 to 8 g per 100 g of the baked product.

The inventors surprisingly discovered that the above carbohydrates having an energy content of below 0.5 kcal/g may be used to successfully replace sugar and fat content in a baked product, thereby reducing the calorific content of the baked product. Incorporation of the above carbohydrates in the amounts claimed surprisingly do not result in significant sensorial cooling and ensure that the sugar alcohols and/or one or more carbohydrates having an energy content of below 0.5 kcal/g in the baked product have a total theoretical heat of solution of less than −6 j/g.

By the term “theoretical heat of solution” it is meant the energy released or absorbed when a material, in its crystalline state, dissolves in water. The theoretical heat of solution of a material may be measured by calorimetry.

The combined total theoretical heat of solution of the one or more sugar alcohols and/or the one or more carbohydrates having an energy content of below 0.5 kcal/g in the baked product may be less than −5.9 J/g, −5.8 J/g, −5.7 J/g, −5.6 J/g, −5.5 J/g, −5.4 J/g, ˜5.3 J/g, −5.2 J/g, −5.1 J/g, −5.0 J/g, −4.9 J/g, −4.8 J/g, −4.7 J/g, or less than −4.6 J/g.

The combined total theoretical heat of solution of the one or more sugar alcohols and/or the one or more carbohydrates having an energy content of below 0.5 kcal/g in the baked product may be calculated by the sum of the heat of solutions of the individual sugar alcohols and/or carbohydrates having an energy content of below 0.5 kcal/g in the baked product in proportion to their weight amount. For example, as seen in Example 1, a baked product having 19.1 g per 100 g of maltitol having an individual heat of solution of −5.5 J/g and 8.2 g per 100 g of erythritol having an individual heat of solution of −42.9 J/g had a combined total theoretical heat of solution of the one or more sugar alcohols and/or the one or more carbohydrates having an energy content of below 0.5 kcal/g of −4.6 J/g.

The inventors discovered that a baked product having the above combined total theoretical heat of solution does not suffer from significant sensorial cooling.

By the term “total fat” it is meant the total fully calorific fat, e.g., fat having at least 7 kcal/g, present.

The baked product may comprise total fat in an amount of no more than 35, 30, 28, 26, 25, 24, 23, 22, 21, 20 g per 100 g of the baked product.

The baked product may comprise total fat in an amount of no more than 16-35, 16-30, 16-28, 16-26, 16-25, 16-24, 16-23, 16-22, 16-21, 16-20 g per 100 g of the baked product.

The inventors discovered that the above amounts of total fat were able to allow the baked product to have an indulgent mouthfeel without excessively increasing the calorie content of the baked product.

The total fat in the baked product may be provided by one or more ingredients selected from the group consisting of canola oil, palm oil, high oleic canola oil, olive oil, ground nut (peanut) oil, almond oil, avocado oil, coffee oil, milk fat, cocoa butter or fraction or equivalents of cocoa butter, polyglycerol esters, glycerophospholipids, mono- and di-glycerides, sucrose monoesters, sorbitan esters, polyethoxylated glycols, agar, albumin, casein, glyceryl monostearate, gums, soaps, Irish moss, egg yolk, lecithin, fats from finely milled nuts and seeds in the form of nut and seed butter or paste, e.g., hazelnut paste, peanut butter, cashew butter, almond butter, sunflower seed butter, sesame seed paste (tahini), pumpkin seed butter, etc., and combinations thereof.

By the term “caloric sugars” it is meant a monosaccharide or disaccharide with an energy content of >3 kcal/g. The caloric sugar may be selected from the group consisting of glucose, fructose, galactose, sucrose, lactose, maltose, isomaltose, isomaltulose, trehalose, trehalulose and sugar hydrates (such as dextrose monohydrate, for example), among others, and combinations thereof.

The baked product may comprise one or more caloric sugars in an amount of from 0.05 to 3.80, 0.05 to 3.60, 0.05 to 3.50, 0.05 to 3.00, 0.05 to 2.50, 0.05 to 2.00, 0.05 to 1.50, 0.05 to 1.00, 0.05 to 0.90, 0.05 to 0.80, 0.10 to 1.00, 0.20 to 1.00, 0.30 to 1.00, 0.10 to 0.90, 0.15 to 0.80, 0.2 to 0.70, 0.25 to 0.65, 0.30 to 0.60, 0.35 to 0.60, or from 0.35 to 0.55 g per 100 g of the baked product.

The inventors discovered that a baked product comprising the above amounts of calorific sugar has an appropriate texture, taste and/or sweetness, whilst not having an excessive calorific content and/or sugar content.

By the term “dietary fibre” it is meant a plant-based carbohydrate which is not digestible in the small intestine. The term has two components, namely insoluble dietary fibres and soluble dietary fibres. Soluble dietary fibres are soluble in water and insoluble dietary fibres are insoluble in water.

By the term “total dietary fibre” it is meant the total dietary fibre content. Total dietary fibre can be measured by various analytical techniques such as AOAC991.43, AOAC2009.01, AOAC2011.25, AOAC2017.16.

Soluble dietary fibres include one or more ingredients selected from the group consisting of polydextrose, inulin, fructo-oligosaccharides, mannotriose, monotetraose, soy bean oligosaccharides, arabinogalactans, xylo-oligosaccharides, xylotriose, xylotertaose, arabinoxylan-oligosaccharides, arabinotriose, arabinotetraose, milk oligosaccharides, 2′-fucosyl lactose, lacto-n-neotetraose, glucan (i.e. glucose containing) oligosaccharides, isomalto-oligosaccharides, (soluble fibre fraction), cello-oligosaccharides (or cellodextrins), resistant dextrins (e.g, soluble corn fibre, soluble wheat fibre, soluble tpioca fibre), nigero-oligosaccharides, nigertriose, nigerotetraose, kojitriose, kojitetraose, dextrans, beta glucans, polydextrose, levans, lichenan, and isolichenan, among others, and combinations thereof.

Insoluble dietary fibres may be provided by one or more ingredients selected from the group consisting of brans, celluloses, hemicelluloses, lignins, resistant starches, flours, insoluble chicory root fibre, isolate plant fibres, cocoa powder, pecan shell fibre, maple fibre, cocoa pod husk fibre, agave pina fibre, among others, and combinations thereof.

The total dietary fibre may be provided by one or more ingredients selected from the group consisting of polydextrose, inulin, fructo-oligosaccharides, mannotriose, monotetraose, soy bean oligosaccharides, arabinogalactans, xylo-oligosaccharides, xylotriose, xylotertaose, arabinoxylan-oligosaccharides, arabinotriose, arabinotetraose, human milk oligosaccharides, 2′-fucosyl lactose, lacto-n-neotetraose, glucan (i.e. glucose containing) oligosaccharides, isomalto-oligosaccharides, (soluble fibre fraction), celo-oligosaccharides (or cellodextrins), resistant dextrins (e.g, soluble com fibre, soluble wheat fibre, soluble tpioca fibre), nigero-oligosaccharides, nigertriose, nigerotetraose, kojitriose, kojitetraose, dextrans, beta glucans, lichenan, isolichenan, brans, celluloses, hemicelluloses, lignins, resistant starches, flours, insoluble chicory root fibre, isolate plant fibres, cocoa powder, pecan shell fibre, maple fibre, cocoa pod husk fibre, agave pina fibre, and combinations thereof.

The baked product may comprise total dietary fibre in an amount of from 1 to 19, 1 to 18, 2 to 17, 3 to 16, 5 to 16, 6 to 16, 7 to 16, 8 to 16, 5 to 20, 5 to 19, 5 to 18, 5 to 17, 5 to 15, 6 to 15, 7 to 14, 8 to 13, or 8 to 12 g per 100 g by weight of the baked product.

The inventors discovered that inclusion of total dietary fibre in the above amounts allows the total fat and sugar in the baked product to be lowered without substantially increasing the risk of digestive intolerance symptoms and without significantly affecting texture, structure and function of the product.

The total moisture by weight of the baked product may be no more than 15 wt. %, 14 wt. %, 13 wt. %, 12 wt. %, or no more than 11 wt. % by weight of the baked product.

The total moisture by weight of the baked product may be from 0.01 to 16 wt. %, 0.01 to 16 wt. %, 0.5 to 16 wt. %, 1 to 16 wt. %, 5 to 16 wt. %, 6 to 16 wt. %, 7 to 16 wt. %, 8 to 16 wt. %, 9 to 16 wt. %, 5 to 16 wt. %, 5 to 15 wt. %, 5 to 14 wt. %, 5 to 13 wt. %, 5 to 12 wt. %, 6 to 15 wt. %, 7 to 14 wt. %, 8 to 13 wt. %, 9 to 12 wt. % or 10 to 12 wt. % by weight of the baked product.

The inventors discovered that the presence of high moisture content in a baked product undesirably impacts texture, typically leading to undesirably soft texture in the baked product, and high moisture can lead to undesirable microbial growth.

The baked product may comprise less than 1665 kJ of energy per 100 g, or less than 1660, 1655, 1650, 1645, 1640, 1635, 1630, 1625, 1620, 1610, 1605, 1600, 1595, 1590, 1585, 1575, 1570, 1565, 1560, 1555, 1550, 1545, 1540, 1535 kJ of energy per 100 g.

The baked product may comprise a farinaceous material. The farinaceous material may comprise flour, which may be any cereal flour such as wheat, oats, com, maize, barley, rye, sorghum, rice or the like, for example. In some embodiments the farinaceous material comprises wheat flour.

The farinaceous material may be present in an amount of at least 15, 20, 25, 30, 35, 40, 45 or 50 g per 100 g of the baked product. The farinaceous material may be present in an amount of no more than 60, 50, 40 or 30 g per 100 g of the baked product. The farnicaeous material may be present in an amount of 15 to 60, 15 to 55, 15 to 50, 15 to 45, 20 to 45, 25 to 45, 30 to 45, 30 to 40, 35 to 40 g per 100 g of the baked product.

The baked product may comprise one or more materials selected from the group comprising a biscuit, cookie, cake, doughnut, cracker, wafer, pretzel, cereal, pastry, tart, biscotti, short breads, muffins, among others.

The baked product may comprise a confectionery component and a baked component.

The confectionery component may comprise at least 20, 21, 22, 23, 24, 25, 26, 27, 28, 29, 30, 31, 32, 33, 34, 35, 36, 37, 38, 39 or 40 g per 100 g by weight of the baked product. The confectionery component may comprise no more than 50, 49, 48, 47, 46, 45, 44, 43, 42, 41, 40, 39, 38, 37, 36, 35, 34, 33, 32, 31, 30, 29, 28, 27, 26 or 25 g per 100 g by weight of the baked product.

The confectionery component may comprise from 20 to 50, 20 to 49, 20 to 48, 20 to 47, 20 to 46, 20 to 45, 20 to 44, 20 to 43, 20 to 42, 20 to 41, 20 to 40, 20 to 39, 20 to 38, 20 to 37, 20 to 36, 20 to 35, 21 to 35, 22 to 35, 23 to 35, 24 to 35, 25 to 35, 26 to 34, 27 to 33, 28 to 32 g per 100 g by weight of the baked product.

The baked component may comprise at least 60, 61, 62, 63, 64, 65, 66, 67, 68, 69, 70, 71, 72, 73, 74, 75, 76, 77, 78, 79 or 80 g per 100 g by weight of the baked product. The confectionery component may comprise no more than 50, 51, 52, 53, 54, 55, 56, 57, 58, 59, 60, 61, 62, 63, 64, 65, 66, 67, 68, 69, 70, 71, 72, 73, 74 or 75 g per 100 g by weight of the baked product.

The baked component may comprise from 50 to 80, 51 to 80, 52 to 80, 53 to 80, 54 to 80, 55 to 80, 56 to 80, 57 to 80, 58 to 80, 59 to 80, 60 to 80, 61 to 80, 62 to 80, 63 to 80, 64 to 80, 65 to 80, 65 to 79, 65 to 78, 65 to 77, 65 to 75, 66 to 75, 67 to 75, 68 to 75, or 68 to 74 g per 100 g of the baked product.

The confectionery component may comprise one or more sugar alcohols in an amount of at least 10, 15, 20, 25, 30, 35, 40, 45, 50, 55, 60 g per 100 g of the confectionery component. The confectionery component may comprise one or more sugar alcohols in an amount of no more than 80, 75, 70, 65, or 60 g per 100 g of the confectionery component.

The confectionery component may comprise one or more sugar alcohols in an amount of from 10 to 80, 15 to 80, 20 to 80, 25 to 80, 30 to 80, 35 to 75, 40 to 70, 45 to 65 or 50 to 65 g per 100 g of the confectionery component.

The baked component may comprise one or more sugar alcohols in at least 5, 10, 15, 20, 25 g per 100 g of the baked component. The baked component may comprise one or more sugar alcohols in an amount of no more than 40, 35, 30, 25, or 20 g per 100 g of the baked component.

The baked component may comprise one or more sugar alcohols in an amount of from 1 to 40, 5 to 35, 10 to 30, 15 to 30, 20 to 30 g per 100 g of the baked component.

The confectionery component may comprise one or more carbohydrates having an energy content of below 0.5 kcal/g in an amount of at least 1, 2, 4, 5, 6 8, 10, 12, 14, 15, 16, 18, or 20 g per 100 g of the confectionery component. The confectionery component may comprise one or more carbohydrates having an energy content of below 0.5 kcal/g in an amount of no more than 40, 35, 30, 25, 20, 15 g per 100 g of the confectionery component.

The confectionery component may comprise one or more carbohydrates having an energy content of below 0.5 kcal/g in an amount of from 1 to 40, 1 to 35, 2 to 35, 4 to 35, 5 to 35, 8 to 35, 10 to 35, 12 to 35, 14 to 15, 20 to 35, 25 to 35, 5 to 30, 5 to 25, 5 to 20, 5 to 15, or 5 to 10 g per 100 g of the confectionery component.

The baked component may comprise one or more carbohydrates having an energy content of below 0.5 kcal/g in an amount of at least 1, 2, 4, 5, 6 8, 10, 12, 14, 15, 16, 18, or 20 g per 100 g of the baked component. The baked component may comprise one or more carbohydrates having an energy content of below 0.5 kcal/g in an amount of no more than 50, 45, 40, 35, 30, 25, 20, 15, 10, 9, 8, 7, 6, 5, 4, 3, 2, 1 g per 100 g of the baked component.

The baked component may comprise one or more carbohydrates having an energy content of below 0.5 kcal/g in an amount of from 1 to 50, 1 to 45, 1 to 40, 1 to 35, 2 to 35, 4 to 35, 5 to 35, 8 to 35, 10 to 35, 12 to 35, 14 to 35, 20 to 35, 25 to 35, 5 to 30, 5 to 25, 5 to 20, 5 to 15, or 5 to 10 g per 100 g of the baked component.

The confectionery component may have a theoretical heat of solution of less than 6 J/g, −5.9 J/g, −5.8 J/g, −5.7 J/g, −5.6 J/g, −5.5 J/g, −5.4 J/g, −5.3 J/g, −5.2 J/g, −5.1 J/g, −5.0 J/g, −4.9 J/g, −4.8 J/g, −4.7 J/g, or less than −4.6 J/g.

The confectionery component may comprise total fat in an amount of no more than 40, 35, 30 g per 100 g of the confectionery component.

The confectionery component may comprise total fat in an amount of 10-40, 15-40, 15-35, 16-34, 17-33, 18-32, 19-31, or 20-30 g per 100 g of the confectionery component.

The baked component may comprise total fat in an amount of no more than 30, 25, 20, 15 g per 100 g of the baked component.

The baked component may comprise total fat in an amount of 0-30, 1-30, 1-25, 1-20, 5-20, 10-20 g per 100 g of the baked component.

The confectionery component may comprise one or more caloric sugars in an amount of less than 1, 0.9, 0.8, 0.7, 0.6, 0.5 g per 100 g of the confectionery component.

The baked component may comprise one or more caloric sugars in an amount of less than 1, 0.9, 0.8, 0.7, 0.6, 0.5 g per 100 g of the baked component.

The confectionery component may comprise total dietary fibre in an amount of at least 5, 10, 15, or 10 g per 100 g of the confectionery component.

The confectionery component may comprise total dietary fibre in an amount of from 1 to 30, 2 to 30, 4 to 30, 5 to 29, 10 to 28, 15 to 25, 16 to 24, 17 to 23, 18 to 22 g per 100 g of the confectionery component.

The baked component may comprise total dietary fibre in an amount of at least 1, 2, 3, 4, 5 g per 100 g of the baked component.

The baked component may comprise total dietary fibre in an amount of from 1 to 20, 1 to 15, 2 to 15, 3 to 15, 4 to 15, 5 to 14, 5 to 13, 5 to 12, 5 to 11, 5 to 10 g per 100 g of the baked component.

The confectionery component may be one or more materials selected from the group comprising a cream, crème, chocolate, hard candy, jelly candy, chewy candy, toffee, fudge, marshmallow, mousse, gel, fondant, jam, fudge, or paste, among others.

The baked component may be one or more of the group comprising a biscuit, cookie, cake, doughnut, cracker, wafer, pretzel, cereal, pastry, tart, biscotti, short breads, muffins, among others.

The baked product may be a filled baked product.

The filled baked product may comprise a confectionery component as a filling.

In such an embodiment, the confectionery component may be partially or fully surrounded by the baked component. The outer surface area of the confectionery component may be at least 50% surrounded by the baked component, or at least 60, 70, 80, or at least 90%, or substantially 100% of the outer surface area of the confectionery component may be surrounded by the baked component.

In one embodiment, the filled baked product may comprise a component selected from the group comprising a cream, crème, chocolate, hard candy, jelly candy, chewy candy, toffee, fudge, marshmallow, mousse, gel, fondant, jam, and/or fudge confectionery component filling surrounded by one or more components selected from the group comprising a biscuit, cookie, cake, doughnut, cracker, wafer, pretzel, cereal, pastry, tart, biscotti, short bread, and/or muffin baked component.

The baked product may comprise a coated or enrobed baked component. The baked product may comprise a layer of a confectionery component coating material on a surface of the baked component, preferably an outer surface. The baked component may comprise a layer of a confectionery component coating material over at least 50% of the outer surface area of the baked component, or over at least 60, 70, 80, 90%, or over substantially 100% of the outer surface area of the baked component. The coating material may be a chocolate confectionery component.

In such an embodiment, the baked product may comprise one or more of the group selected from a biscuit, cookie, cake, doughnut, cracker, wafer, pretzel, cercal, pastry, tart, biscotti, short bread, and/or muffin baked component coated or enrobed with a chocolate confectionery component.

The term ‘chocolate’ includes any material that meets a legal definition of chocolate in any jurisdiction. However, the term ‘chocolate’ is not limited to material which meets any legal definition of chocolate and also includes chocolate substitutes and analogues. For instance, ‘chocolate’ herein includes materials in which all or part of the cocoa butter (CB) of legally or regulatory-defined chocolate is replaced by cocoa butter equivalents (CBE), cocoa butter substitutes (CBS), cocoa butter replacers (CBR) and/or other lipids. For example, the term “chocolate” also includes chocolates in which part, or all the cocoa butter has been replaced by vegetable fat.

The term ‘cocoa’, as used in any context throughout this specification, is also taken to include the tautologous terminology ‘cacao’.

The chocolate confectionery component may be a non-milk or low milk containing (commonly referred to as plain and/or dark), milk, compound, or white chocolate.

The baked product may comprise a panned coating of a confectionery component on a baked component.

In one embodiment, the baked product may comprise one or more layers of a confectionery component and one or more layers of a baked product. The layers may have an even or uneven thickness. The layers may have a thickness of at least 1, 2, 3, 4, or at least 5 mm. The layer may have a thickness of no greater than 10, 9, 8, 7, 6, or no greater than 5 mm.

In such an embodiment, the baked product may comprise alternating layers of a confectionery component and a baked component. For example, the baked product may comprise a layer of one or more materials selected from the group comprising a cream, chocolate, jelly, toffee, fudge, and/or jam confectionery component sandwiched between two layers of one or more materials selected from the group comprising a biscuit, cookie, cracker, wafer and/or short bread baked component.

In one embodiment, the baked product may comprise a baked component and more than one confectionery component. The baked product may comprise a baked component and a plurality of confectionery components.

In such an embodiment, the confectionery component may be distributed throughout the baked component. For example, the baked product may comprise a cookie or biscuit baked component with a plurality of chocolate chip confectionery components distributed throughout the baked component.

According to a second aspect of the invention, there is provided a method for preparing a baked product according to the first aspect of the invention, the method comprising the steps of providing a baked component and providing a confectionery component and depositing the confectionery component into or onto the baked product.

The method may comprise depositing one or more confectionery components into the baked product. The method may comprise depositing a plurality of confectionery components into the baked product.

In one embodiment, the confectionery component may be deposited onto a layer of the baked component. In such an embodiment, the confectionery component may be deposited as a layer onto a layer of a baked component.

In a further embodiment, the method may comprise the steps of providing a first baked component, a second baked component, and a confectionery component; depositing the confectionery component onto the first baked component; and depositing the second baked component onto the confectionery component.

Alternatively, the method may comprise the step of providing a baked component and a confectionery component, and coating the baked component with the confectionery component.

Any suitable method of coating known to those skilled in the art may be employed. Such a method may provide a layer of the confectionery component on a surface of the baked component. The method may comprise coating a layer of the confectionery component on at least 50% of the outer surface area of the baked component, or on at least 60, 70, 80, 90%, or on substantially 100% of the outer surface area of the confectionery component.

In some embodiments, the step of coating may comprise enrobing the baked component with a confectionery component. The method may comprise passing the baked component through a curtain or stream of the confectionery component. In one embodiment, the curtain or stream may be formed by a chocolate confectionery component falling from an elevated position relative to the baked component. The molten chocolate confectionery component may fall from an elevated trough or like device fed from a suitable container.

In some embodiments, the step of coating may comprise dipping the baked component into a confectionery component. Suitable methods of dipping include hand-dipping and dipping the baked component using suitable machinery known in the art.

In some embodiments, the step of coating may comprise pan coating the baked component with a confectionery component. Pan coating is known to those skilled in the art and makes use of rotating drums to coat a baked component with a confectionery component. The pan coating method may include but is not limited to one or more of: spray pan coating, ladling, and drip-feeding.

Alternatively, the method may comprise filling a baked component with a confectionery component. Any suitable method of filling known to those skilled in the art may be employed.

According to a third aspect of the present invention, there is provided a packaged baked product according to the first aspect of the invention.

The baked product may be packaged in any suitable packaging material, which may in some embodiments be any one or more materials independently selected from the group comprising cardboard, paper, paperboard, flow-wrap plastics, metal foil, plastics foil and combinations and laminates thereof.

Suitable packaging for the baked product may be reclosable or not reclosable (or resealable or not resealable) as known to a person skilled in the art.

The further aspects of the present invention may incorporate any of the features of the other aspects of the invention described herein as desired or as appropriate.

### DETAILED DESCRIPTION OF THE INVENTION

In order that the invention may be more clearly understood one or more embodiments thereof will now be described, by way of example:

### Example 1

A baked product in the form of a sandwich cookie was produced containing the ingredients shown in Table 1 below. The baked product comprised a cream confectionery component and a biscuit baked component. The cream confectionery component was in the form of a layer sandwiched between two layers of a biscuit baked component.

To prepare the biscuit component, soluble corn fibre and baking soda were dissolved in water and the resulting solution was mixed with maltitol, salt and low-fat cocoa powder in a stand mixer (Hobart) with a paddle attachment. The ingredients were mixed at a setting of ‘1’ for 2 minutes, followed by mixing at a setting of ‘2’ for 1 minute. Next, oil and lecithin were heated in a microwave for 1 minute and then added into the mixer and mixed at a setting of ‘2’ for 1.5 minutes. Flour was then added to the mixer and the resulting mixture was mixed at a setting of ‘1’ for 1.5 minute, followed by mixing at a setting of ‘2’ for 3.5 minutes.

The resultant dough was consolidated into a mass and tightly wrapped in a piece of plastic wrap (Saran wrap) and stored at ambient temperature for 30 minutes. After the 30 minutes, the dough, which now had a water activity of 0.77 was unwrapped and placed between two sheets of wax paper to create a sheeted dough with a thickness of 2 mm. The sheeted dough was then cut into squares and baked at 350° F. (177° C.) in a convection (Combi) oven for 18 minutes.

The cream confectionery component was prepared by adding the ingredients in the confectionery component column of Table 1 into a plastic jar and mixing for 45 seconds at 2500 rpm in a speed mixer (FlackTek).

The cream confectionery component was then sandwiched between two layers of square cut dough to form a sandwich cookie. The resultant baked product comprised a confectionery component in an amount of 29.1 g per 100 g of the baked product and a baked component in an amount of 70.9 g per 100 g of the baked product.

The resultant sandwich cookie had a sweet taste and indulgent mouthfeel, whilst possessing less than 1670 KJ per 100 g, no laxative effect, no undesirable flatulence and bloating and a low level of cooling. The product nutrition of the sandwich cookie is shown in Table 1 and 2 below.

TABLE 1
Ingredient nutritional profile and product nutritional information for Example 1.

| | Confectionery | Baked | Baked | Product nutrition/ | | | | |
|---|---|---|---|---|---|---|---|---|
| | component/ | component/ | product/ | 100 g | | | | ΔH soln |
| Ingredient | 100 g | 100 g | 100 g | cals | fat | sugars | TDF | J/g |
| Maltitol | 8.3 | 23.42 | 19.1 | 45.8 | — | — | — | −1.05 |
| fat, Palm - | 31.0 | — | 9.0 | 81.2 | 9.0 | — | — | — |
| STHF | | | | | | | | |
| (Bunge | | | | | | | | |
| Loders | | | | | | | | |
| Croklaan) | | | | | | | | |
| Canola oil | — | 12.60 | 9.0 | 80.8 | 9.0 | — | — | — |
| Erythritol | 28.1 | — | 8.2 | — | — | — | — | −3.51 |
| water | — | 16.00 | 11.4 | — | — | — | — | — |
| moisture | — | (16.00) | (11.4) | | | | — | — |
| bakeoff | | | | | | | | |
| flour | — | 51.00 | 36.3 | 123.5 | 0.5 | 0.2 | 1.0 | — |
| Defatted | — | 8.00 | 5.7 | 13.7 | 0.1 | 0.0 | 2.1 | — |
| cocoa | | | | | | | | |
| powder | | | | | | | | |
| (Bensdorp) | | | | | | | | |
| corn | 6.5 | — | 1.9 | 6.6 | — | — | — | — |
| starch | | | | | | | | |
| (Melojel ®) | | | | | | | | |
| salt | — | 0.50 | 0.36 | — | — | — | — | — |
| Sodium | — | 0.60 | 0.43 | — | — | — | — | — |
| Bicarb | | | | | | | | |
| Lecithin | — | 0.38 | 0.27 | 1.9 | 0.1 | 0.0 | — | — |
| Flavor | — | 0.0033 | 0.00 | 0.0 | — | — | — | — |
| soluble | 26.0 | 3.0 | 9.7 | 21.4 | — | 0.2 | 7.8 | — |
| corn fiber | | | | | | | | |
| (Promitor ® | | | | | | | | |
| 85) | | | | | | | | |
| Total | 29.1 | 70.9 | 100 | 375.2 | 18.8 | 0.4 | 10.9 | −4.6 |

TABLE 2
Baked product nutritional information for Example 1.

| | per 100 g product | |
|---|---|---|
| Discrete confectionery | 29.1 | g |
| component | | |
| Energy | 1568.1 | kJ |
| Fat | 18.8 | g |
| Sugars | 0.4 | g |
| Fiber (TDF) | 10.9 | g |
| Sugar alcohols | 27.3 | g |
| Carbs with energy content below | 8.2 | g |
| 0.5 kcal/g (erythritol, allulose, | | |
| etc.) | | |
| Heat of solution of sugar | −4.6 | J/g |
| alcohols + Carbs with energy | | |
| content below 0.5 kcal/g | | |
| (erythritol, allulose, etc.) | | |

### Example 2

A baked product in the form of a sandwich cookie was produced containing the ingredients shown in Table 3 below. The baked product comprised a cream confectionery component and a biscuit baked component. The cream confectionery component was in the form of a layer sandwich between two layers of biscuit baked component.

To prepare the biscuit component, water was heated in a microwave for 1 minute and then soluble corn fibre, baking soda, ammonium bicarbonate and potassium bicarbonate were dissolved in the water and the resulting solution was mixed with maltitol, wheat starch, low sodium alkalised cocoa powder and salt in a stand mixer (Hobart) with a paddle attachment. The ingredients were mixed at a setting of ‘1’ for 1 minute, followed by mixing at a setting of ‘2’ for 2 minutes. Next, oil and lecithin were heated in a microwave for 1 minute and then added into the mixer and mixed at a setting of ‘2’ for 1 minute. Wheat Flour was then added to the mixer and the resulting mixture was mixed at a setting of ‘1’ for 1.5 minute, followed by mixing at a setting of ‘2’ for 3.5 minutes.

The mixing bowl was covered in a piece of plastic wrap (Saran wrap) and stored at ambient temperature for 30 minutes. After the 30 minutes, the dough, which now had a water activity of 0.76 was unwrapped and placed between two sheets of wax paper to create a sheeted dough with a thickness of 2 mm. The sheeted dough was then cut into circles and baked at 350° F. (177° C.) in a convection (Combi) oven for 21 minutes.

The cream confectionery component was prepared by adding the ingredients in the confectionery component column of Table 3 into a plastic jar and mixing for 45 seconds at 2500 rpm in a speed mixer (FlackTek).

The cream confectionery component was then sandwiched between two layers of circle cut dough to form a sandwich cookie. The resultant baked product comprised a confectionery component in an amount of 29.1 g per 100 g of the baked product and a baked component in an amount of 70.9 g per 100 g of the baked product.

The resultant sandwich cookie had a sweet taste and indulgent mouthfeel, whilst possessing less than 1670 KJ per 100 g, no laxative effect, no undesirable flatulence and bloating and a low level of cooling. The product nutrition of the sandwich cookie is shown in Table 3 and 4 below.

TABLE 3
Ingredient nutritional profile and product nutritional information for Example 2.

| | Confectionery | Baked | Baked | | | | | |
|---|---|---|---|---|---|---|---|---|
| | component/ | component/ | product/ | Product nutrition/100 g | | | | ΔH soln |
| Ingredient | 100 g | 100 g | 100 g | cals | fat | sugars | TDF | J//g |
| Maltitol | 8.3 | 23.1 | 18.8 | 45.2 | — | — | — | −1.03 |
| fat, Palm - | 31.0 | — | 9.0 | 81.2 | 9.0 | — | — | — |
| STHF | | | | | | | | |
| (Bunge | | | | | | | | |
| Loders | | | | | | | | |
| Croklaan) | | | | | | | | |
| Canola oil | — | 14.1 | 10.0 | 90.0 | 10.0 | — | — | — |
| Erythritol | 28.1 | — | 8.2 | — | — | — | — | −3.51 |
| water | — | 12.8 | 9.0 | — | — | — | — | — |
| moisture | — | (16.3) | (11.5) | | | | — | — |
| bakeoff | | | | | | | | |
| flour | — | 51.9 | 36.8 | 125.1 | 0.5 | 0.18 | 1.0 | — |
| Native | 6.5 | 3.4 | 4.3 | 15.2 | 0.0 | — | 0.0 | — |
| wheat starch | | | | | | | | |
| (Aytex ® P) | | | | | | | | |
| low sodium | — | 6.4 | 4.6 | 9.2 | 0.5 | 0.21 | 1.3 | — |
| Alkalized | | | | | | | | |
| cocoa | | | | | | | | |
| powder | | | | | | | | |
| salt | — | 0.41 | 0.29 | — | — | — | — | — |
| Ammonium | — | 0.28 | 0.20 | 1.1 | 0.2 | 0.00 | — | — |
| Bicarb | | | | | | | | |
| Sodium | — | 0.25 | 0.17 | — | — | — | — | — |
| Bicarb | | | | | | | | |
| Potassium | — | 0.37 | 0.27 | — | — | — | — | — |
| Bicarb | | | | | | | | |
| Lecithin | 0.05 | 0.34 | 0.26 | 1.8 | 0.1 | 0.01 | — | — |
| Flavor | 0.05 | 0.05 | 0.05 | 0.0 | — | — | — | — |
| (Vanillin) | | | | | | | | |
| soluble corn | 26.0 | 2.8 | 9.6 | 21.1 | — | 0.18 | 7.7 | — |
| fiber | | | | | | | | |
| (Promitor ® | | | | | | | | |
| 85) | | | | | | | | |
| Total | 29.1 | 70.9 | 100 | 389.9 | 20.3 | 0.58 | 10.1 | −4.5 |

TABLE 4
Baked product nutritional information for Example 2.

| | per 100 g product | |
|---|---|---|
| Discrete confectionery | 29.1 | g |
| component | | |
| Energy | 1629.9 | kJ |
| Fat | 20.3 | g |
| Sugars | 0.6 | g |
| Fiber (TDF) | 10.1 | g |
| Sugar alcohols | 27.0 | |
| Carbs with energy content | 8.2 | g |
| below 0.5 kcal/g (erythritol, | | |
| allulose, etc.) | | |
| Heat of solution of sugar | −4.5 | J/g |
| alcohols + Carbs with energy | | |
| content below 0.5 kcal/g | | |
| (erythritol, allulose, etc.) | | |

### Example 3

A baked product in the form of a chocolate biscuit was produced containing the ingredients shown in Table 5 below. The baked product comprised a chocolate confectionery component and a biscuit baked component. The baked component was coated with the chocolate confectionery component.

To prepare the biscuit component, soluble corn fibre and baking soda were dissolved in water and the resulting solution was mixed with maltitol, salt and low fat cocoa powder in a stand mixer (Hobart) with a paddle attachment. The ingredients were mixed at a setting of ‘1’ for 2 minutes, followed by mixing at a setting of ‘2’ for 1 minute. Next, oil and lecithin were heated in a microwave for 1 minute and then added into the mixer and mixed at a setting of ‘2’ for 1.5 minutes. Flour was then added to the mixer and the resulting mixture was mixed at a setting of ‘1’ for 1.5 minute, followed by mixing at a setting of ‘2’ for 3.5 minutes.

The resultant dough was consolidated into a mass and tightly wrapped in a piece of plastic wrap (Saran wrap) and stored at ambient temperature for 30 minutes. After the 30 minutes, the dough, which now had a water activity of 0.77 was unwrapped and placed between two sheets of wax paper to create a sheeted dough with a thickness of 2 mm. The sheeted dough was then cut into squares and baked at 350° F. (177° C.) in a convection (Combi) oven for 18 minutes to produce a biscuit baked component.

The chocolate confectionery component was prepared by melting pre-refined cocoa-liquor in a heat jacketed kitchen aid bowl at 55° C. and mixed on setting ‘4’ for 15 minutes. Maltitol and Erythritol were then added to the bowl and mixed for 20 minutes on setting ‘4’. Soluble corn fibre and defatted cocoa powder were then added and mixed on setting ‘4’ for 30 minutes. The Heat jacket was then increased to 65° C. and the mass was mixed for 30 minutes (conching). A third of the mass was then removed and left to cool at ambient temperature (this was used to “seed” the chocolate). The remaining molten chocolate mass was mixed for an additional 1.5 hours. The heat jacket was then cooled to 55° C. and the emulsifiers polyglycerol polyricinoleate (PGPR) and soy lecithin were mixed in at a setting of ‘4’ for 10 minutes. The mixing bowl was then placed into a cold jacket and mixed on setting ‘4’ until the chocolate mass had reached 29° C. Once cooled the seeding chocolate was added and mixed until the mass appeared dull (i.e., lost sheen). The mixing bowl was then transferred to a jacket preheated to 35° C. Once the chocolate mass was at 35° C. it was ready to add to the cooled biscuits.

26% by weight of the chocolate mass was then placed on a parchment paper and the biscuit baked component was pressed down until the chocolate fully covered the top of the biscuit. The chocolate topped biscuits were left to cool overnight before the parchment paper was removed.

The resultant baked product comprised a confectionery component in an amount of 26 g per 100 g of the baked product and a baked component in an amount of 74 g per 100 g of the baked product.

The resultant chocolate coated biscuit had a sweet taste and indulgent mouthfeel, whilst possessing less than 1670 KJ per 100 g, no laxative effect, no undesirable flatulence and bloating and a low level of cooling. The product nutrition of the chocolate coated chocolate biscuit is shown in Table 5 and 6 below.

TABLE 5
Ingredient nutritional profile and product nutritional information for Example 3.

| | Confectionery | Baked | Baked | | | | | |
|---|---|---|---|---|---|---|---|---|
| | component/ | component/ | product/ | Product nutrition/100 g | | | | ΔH soln |
| Ingredient | 100 g | 100 g | 100 g | cals | fat | sugars | TDF | J/g |
| Maltitol | 34.6 | 23.42 | 26.3 | 63.2 | — | — | — | −1.45 |
| fat, Palm - | — | — | — | — | — | — | — | — |
| STHF (Bunge | | | | | | | | |
| Loders | | | | | | | | |
| Croklaan) | | | | | | | | |
| Canola oil | — | 12.60 | 9.3 | 83.9 | 9.3 | — | — | — |
| Erythritol | 7.3 | — | 1.9 | — | — | — | — | −0.82 |
| water | — | 16.00 | 11.8 | — | — | — | — | — |
| moisture | — | (16.00) | (11.8) | — | — | — | — | — |
| bakeoff | | | | | | | | |
| flour | — | 51.00 | 37.7 | 128.3 | 0.5 | 0.2 | 1.0 | — |
| Defatted | 3.1 | 8.00 | 6.7 | 16.2 | 0.1 | 0.0 | 2.5 | — |
| cocoa powder | | | | | | | | |
| (Bensdorp) | | | | | | | | |
| corn starch | — | — | — | — | — | — | — | — |
| (Melojel ®) | | | | | | | | |
| salt | — | 0.50 | 0.4 | — | — | — | — | — |
| Sodium | — | 0.60 | 0.4 | — | — | — | — | — |
| Bicarb | | | | | | | | |
| Lecithin | 0.8 | 0.38 | 0.5 | 3.5 | 0.4 | 0.0 | — | — |
| Flavor | — | 0.0033 | 0.0 | 0.0 | — | — | — | — |
| Cocoa Liquor | 47.3 | — | 12.3 | 62.7 | 6.6 | 0.0 | 2.3 | |
| (Barry | | | | | | | | |
| Callebaut) | | | | | | | | |
| PGPR | 0.38 | — | 0.1 | 0.9 | 0.1 | — | — | |
| soluble corn | 6.5 | 3.0 | 3.9 | 8.6 | — | 0.1 | 3.2 | — |
| fiber | | | | | | | | |
| (Promitor ® | | | | | | | | |
| 85) | | | | | | | | |
| Total | 26.0 | 74.0 | 100 | 367.3 | 16.9 | 0.4 | 9.0 | −2.3 |

TABLE 6
Baked product nutritional information for Example 3.

per 100 g product

| | | |
|---|---|---|
| Discrete confectionery component | 26.0 | g |
| Energy | 1535.4 | kJ |
| Fat | 16.9 | g |
| Sugars | 0.4 | g |
| Fiber (TDF) | 9.0 | g |
| Sugar alcohols | 28.2 | g |
| Carbs with energy content below 0.5 | 1.9 | g |
| kcal/g (erythritol, allulose, etc.) | | |
| Heat of solution of sugar alcohols + | −2.3 | J/g |
| Carbs with energy content below 0.5 | | |
| kcal/g (erythritol, allulose, etc.) | | |

The one or more embodiments are described above by way of example only. Many variations are possible without departing from the scope of protection afforded by the appended claims.

### Example 4

A baked product in the form of a sandwich cookie was produced containing the ingredients shown in Table 7 below. The baked product comprised a chocolate cream confectionery component and a biscuit baked component. The cream confectionery component was in the form of a layer sandwich between two layers of biscuit baked component.

To prepare the biscuit component, oat bran powder, maltitol, salt, vanillin (flavor), whole milk powder, canola oil and lecithin were mixed in a stand mixer (Kitchenaid KSMC505) with a paddle attachment at a setting of “2” for 1 min, followed by mixing at “5” for 1 minute. The resultant suspension achieved a creamy, shortening-like appearance. Next, flour, soluble com fibre and leavening agents (ammonium bicarbonate, potassium bicarbonate and sodium hydroxide) were added into the bowl, followed by mixing at “1” for 3 minutes. Finally, water was added, followed by mixing at “1” for another 1 minute.

The resultant soft dough was consolidated into a mass and tightly wrapped in a piece of plastic wrap (Saran wrap) and stored in a refrigerator at 2.78° C. (37° F.) for 30 minutes. After lay time, the dough achieved a water activity of 0.77 and a had compressive force (texture) of 1078 g upon 15 mm penetration with a ball probe using a TAXT texture analyzer (LFRA method).

The dough was unwrapped and placed between two sheets of wax paper to create a sheeted dough with a thickness of 2 mm. The sheeted dough was then cut into circles using a fluted cutter and baked at 350° F. (177° C.) in a large rotary oven for 23 minutes. The resultant biscuit had a post-bake moisture content of 2%.

The cream confectionery component was prepared by adding the ingredients in the confectionery component column of Table 7 into a plastic jar and mixing for 45 seconds at 2500 rpm in a speed mixer (FlackTek).

The cream confectionery component was then sandwiched between two layers of circle cut dough to form a sandwich cookie. The resultant baked product comprised a confectionery component in an amount of 34.7 g per 100 g of the baked product and a baked component in an amount of 65.3 g per 100 g of the baked product.

The resultant sandwich cookie had a sweet taste and indulgent mouthfeel, whilst possessing less than 1670 KJ per 100 g, no laxative effect, no undesirable flatulence and bloating and a low level of cooling. The product nutrition of the sandwich cookie is shown in Table 7 and 8 below.

TABLE 7
Ingredient nutritional profile and product nutritional information for Example 4.

| | Confectionery | Baked | Baked | | | | | |
|---|---|---|---|---|---|---|---|---|
| | component/ | component/ | product/ | Product nutrition/100 g | | | | ΔH soln |
| Ingredient | 100 g | 100 g | 100 g | cals | fat | sugars | TDF | J/g |
| Maltitol | 6.5 | 19.80 | 15.2 | 36.4 | — | — | — | −0.84 |
| fat, Palm - | 23.1 | — | 8.0 | 72.2 | 8.0 | — | — | — |
| STHF (Bunge | | | | | | | | |
| Loders | | | | | | | | |
| Croklaan) | | | | | | | | |
| Canola oil | 4.2 | 9.40 | 7.6 | 68.4 | 7.6 | — | — | — |
| Erythritol | 21.9 | — | 7.6 | — | — | — | — | −3.26 |
| water | — | 23.30 | 15.2 | — | — | — | — | — |
| moisture | — | (130.70) | (20.0) | — | — | 1 | 2 | |
| bakeoff | | | | | | | | |
| flour | — | 70.40 | 46.0 | 156.3 | 0.6 | 0.2 | 1.0 | — |
| Defatted cocoa | 13.1 | — | 4.5 | 11.0 | 0.0 | 0.0 | 2.5 | — |
| powder | | | | | | | | |
| (Bensdorp) | | | | | | | | |
| Native wheat | 3.7 | — | 1.3 | 4.5 | 0.0 | — | — | — |
| starch (Aytex ® | | | | | | | | |
| PI | | | | | | | | |
| Oat Bran | — | 4.0 | 2.6 | 9.3 | 0.2 | 0.0 | | |
| powder (Grain | | | | | | | | |
| millers) | | | | | | | | |
| salt | — | 0.49 | 0.3 | — | — | — | — | — |
| Ammonium | — | 0.57 | 0.4 | — | — | — | — | — |
| Bicarbonate | | | | | | | | |
| Potassium | — | 0.35 | 0.2 | — | — | — | | |
| Bicarbonate | | | | | | | | |
| Sodium | — | 0.01 | 0.0 | — | — | — | | |
| Hydroxide | | | | | | | | |
| Liquid (10% | | | | | | | | |
| dilution) | | | | | | | | |
| Lecithin | 0.3 | 0.44 | 0.4 | 2.8 | 0.3 | 0.0 | — | — |
| Flavor | — | 0.01 | 0.0 | 0.0 | — | — | — | — |
| Whole milk | 0.1 | 0.60 | 0.4 | 2.2 | 0.2 | 0.0 | 2.3 | |
| powder | | | | | | | | |
| High Amylose | 7.00 | — | 2.4 | 7.0 | 0.0 | 0.0 | — | |
| wheat flour, | | | | | | | | |
| refined | | | | | | | | |
| (Healthsense) | | | | | | | | |
| soluble corn | 20.3 | 1.5 | 8.0 | 17.6 | — | 0.2 | 3.2 | — |
| fiber | | | | | | | | |
| (Promitor@ 85) | | | | | | | | |
| Total | 34.7 | 65.3 | 100 | 387.7 | 17.0 | 0.5 | 10.7 | −4.1 |

TABLE 8
Baked product nutritional information for Example 4.

per 100 g product

| | | |
|---|---|---|
| Discrete confectionery component | 26.0 | g |
| Energy | 1620.5 | kJ |
| Fat | 17 | g |
| Sugars | 0.5 | g |
| Fiber (TDF) | 10.7 | g |
| Sugar alcohols | 22.8 | g |
| Carbs with energy content below 0.5 | 7.6 | g |
| kcal/g (erythritol, allulose, etc.) | | |
| Heat of solution of sugar alcohols + | −4.1 | J/g |
| Carbs with energy content below 0.5 | | |
| kcal/g (erythritol, allulose, etc.) | | |

### Example 5

A baked product in the form of a vanilla biscuit was produced containing the ingredients shown in Table 9 below. The baked product comprised a chocolate confectionery component and a biscuit baked component. The baked component was coated with the chocolate confectionery component.

To prepare the biscuit component, soluble com fibre, potassium bicarbonate and baking soda were dissolved in water and the resulting solution was mixed with maltitol, salt, oat fiber and vanillin (flavor) in a stand mixer (Hobart) with a paddle attachment. The ingredients were mixed at a setting of ‘1’ for 2 minutes, followed by mixing at a setting of ‘2’ for 1 minute. Next, oil and lecithin were heated in a microwave for 1 minute and then added into the mixer and mixed at a setting of ‘2’ for 1.5 minutes. Flour was then added to the mixer and the resulting mixture was mixed at a setting of ‘1’ for 1.5 minute, followed by mixing at a setting of ‘2’ for 3.5 minutes.

The resultant dough was consolidated into a mass and tightly wrapped in a piece of plastic wrap (Saran wrap) and stored at ambient temperature for 30 minutes. After the 30 minutes, the dough, which now had a water activity of 0.757 was unwrapped and placed between two sheets of wax paper to create a sheeted dough with a thickness of 2 mm. The sheeted dough was then cut into squares and baked at 350° F. (177° C.) in a large rotary oven for 18 minutes to produce a biscuit baked component.

The chocolate confectionery component was prepared by melting cocoa butter and pre-refined cocoa-liquor in a heat jacketed kitchen aid bowl at 55° C. and mixed on setting ‘4’ for 15 minutes. Maltitol and Erythritol were then added to the bowl and mixed for 20 minutes on setting ‘4’. Soluble corn fibre and defatted cocoa powder were then added and mixed on setting ‘4’ for 30 minutes. The Heat jacket was then increased to 65° C. and the mass was mixed for 30 minutes (conching). A third of the mass was then removed and left to cool at ambient temperature (this was used to “seed” the chocolate). The remaining molten chocolate mass was mixed for an additional 1.5 hours. The heat jacket was then cooled to 55° C. and the emulsifiers polyglycerol polyricinoleate (PGPR) and soy lecithin were mixed in at a setting of ‘4’ for 10 minutes. The mixing bowl was then placed into a cold jacket and mixed on setting ‘4’ until the chocolate mass had reached 29° C. Once cooled the seeding chocolate was added and mixed until the mass appeared dull (i.e., lost sheen). The mixing bowl was then transferred to a jacket preheated to 35° C. Once the chocolate mass was at 35° C. it was ready to add to the cooled biscuits.

32% by weight of the chocolate mass was then placed on a parchment paper and the biscuit baked component was pressed down until the chocolate fully covered the top of the biscuit. The chocolate topped biscuits were left to cool overnight before the parchment paper was removed.

The resultant baked product comprised a confectionery component in an amount of 32 g per 100 g of the baked product and a baked component in an amount of 68 g per 100 g of the baked product.

The resultant chocolate coated biscuit had a sweet taste and indulgent mouthfeel, whilst possessing less than 1670 KJ per 100 g, no laxative effect, no undesirable flatulence and bloating and a low level of cooling. The product nutrition of the chocolate coated biscuit is shown in Table 9 and 10 below.

TABLE 9
Ingredient nutritional profile and product nutritional information for Example 5.

| | Confectionery | Baked | Baked | | | | | |
|---|---|---|---|---|---|---|---|---|
| | component/ | component/ | product/ | Product nutrition/100 g | | | | ΔH soln |
| Ingredient | 100 g | 100 g | 100 g | cals | fat | sugars | TDF | J/g |
| Maltitol | 40.0 | 23.50 | 28.8 | 69.1 | — | — | — | −1.58 |
| fat, Palm - | — | — | — | — | — | — | — | — |
| STHF (Bunge | | | | | | | | |
| Loders | | | | | | | | |
| Croklaan) | | | | | | | | |
| Canola oil | — | 12.70 | 8.6 | 77.7 | 8.6 | — | — | — |
| Erythritol | 6.0 | — | 1.9 | — | — | — | — | −0.82 |
| water | — | 14.10 | 9.6 | — | — | — | — | — |
| moisture | — | (14.10) | (9.6) | — | — | — | — | — |
| bakeoff | | | | | | | | |
| four | — | 54.20 | 36.9 | 125.3 | 0.5 | 0.2 | 1.0 | — |
| Oat fibre | — | 5.00 | 3.4 | 6.8 | 0.0 | — | 3.0 | — |
| powder (JRS | | | | | | | | |
| HF401-30) | | | | | | | | |
| Cocoa butter | 8.0 | — | 2.6 | 23.0 | 2.6 | — | — | — |
| (Barry | | | | | | | | |
| Callebaut) | | | | | | | | |
| Defatted cocoa | 2.5 | — | 0.8 | 1.9 | 0.0 | 0.0 | 0.3 | — |
| powder | | | | | | | | |
| (Benadorp) | | | | | | | | |
| salt | — | 0.40 | 0.3 | — | — | — | — | — |
| Potassium | — | 0.45 | 0.3 | — | — | — | — | — |
| Bicarbonate | | | | | | | | |
| Sodium | — | 0.30 | 0.2 | — | — | — | | |
| Bicarbonate | | | | | | | | |
| Lecithin | 1.0 | 0.38 | 0.6 | 4.2 | 0.4 | 0.0 | — | — |
| Flavor | — | 0.05 | 0.0 | 0.0 | — | — | — | — |
| Cocoa liquor | 32.0 | — | 10.2 | 52.2 | 5.5 | 0.0 | 1.9 | |
| (Barry | | | | | | | | |
| Callebaut) | | | | | | | | |
| PGPR | 0.50 | — | 0.2 | 1.4 | 0.2 | — | — | |
| soluble corn | 10.0 | 3.0 | 5.2 | 11.5 | — | 0.1 | 4.2 | — |
| fiber | | | | | | | | |
| (Promitor ® 85) | | | | | | | | |
| Total | 32.0 | 68.0 | 100 | 373.2 | 17.8 | 0.3 | 10.5 | −2.4 |

TABLE 10
Baked product nutritional information for Example 5.

per 100 g product

| | | |
|---|---|---|
| Discrete confectionery component | 26.0 | g |
| Energy | 1560.0 | kJ |
| Fat | 17.8 | g |
| Sugars | 0.3 | g |
| Fiber (TDF) | 10.5 | g |
| Sugar alcohols | 30.7 | g |
| Carbs with energy content below 0.5 | 1.9 | g |
| kcal/g (erythritol, allulose, etc.) | | |
| Heat of solution of sugar alcohols + | −2.4 | J/g |
| Carbs with energy content below 0.5 | | |
| kcal/g (erythritol, allulose, etc.) | | |

### Example 6

A baked product in the form of a rotary molded chocolate biscuit was produced containing the ingredients shown in Table 11 below. The baked product comprised a chocolate confectionery component and a biscuit baked component. The baked component was coated with the chocolate confectionery component.

The biscuit was prepared by first dissolving maltitol and soluble corn fiber with water (preheated to 47.8° C. (118° F.)) in a Triumph horizontal dough mixer for 2 minutes at 20 rpm (stage 1). Next, canola oil was preheated in a microwave for 1 minute and added into the mixer, along with lecithin, cocoa, wheat starch, salt, ammonium bicarbonate, potassium bicarbonate and baking soda and mixed for 5 minutes at 40 rpm, resulting in a black, oily slurry. Finally, flour was added to the mixer and mixed for 4 minutes at 40 rpm. The resultant dough was collected in a large bucket, which was then covered with plastic wrap (Saran wrap) and stored at ambient temperature for 30 minutes after which it achieved a water activity of 0.73 and compressive force of 1112 g upon 15 mm penetration with a ball probe on a TAXT texture analyzer (LFRA method).

The dough was passed through a rotary molder, which converted it into circular discs with engravings on the surface. These were collected onto a belt (stainless steel mesh), and passed through an oven with 5 temperature zones. Process conditions, including rotary molder settings, oven belt speed and oven zone temperatures were optimized until the target moisture bakeoff [(dough weight-biscuit weight)×100/dough weight] of 16.3% and biscuit moisture of 2.5% was achieved.

The chocolate component was prepared in identical fashion to Example 5.

29% by weight of the chocolate mass was then placed on a parchment paper and the biscuit baked component was pressed down until the chocolate fully covered the top of the biscuit. The chocolate topped biscuits were left to cool overnight before the parchment paper was removed.

The resultant baked product comprised a confectionery component in an amount of 29 g per 100 g of the baked product and a baked component in an amount of 71 g per 100 g of the baked product.

The resultant chocolate coated biscuit had a sweet taste and indulgent mouthfeel, whilst possessing less than 1670 KJ per 100 g, no laxative effect, no undesirable flatulence and bloating and a low level of cooling. The product nutrition of the chocolate coated biscuit is shown in Table 11 and 12 below.

TABLE 11
Ingredient nutritional profile and product nutritional information for Example 6.

| | Confectionery | Baked | Baked | | | | | |
|---|---|---|---|---|---|---|---|---|
| | component/ | component/ | product/ | Product nutrition/100 g | | | | ΔH soln |
| Ingredient | 100 g | 100 g | 100 g | cals | fat | sugars | TDF | J/g |
| Maltitol | 40.0 | 23.10 | 28.0 | 67.2 | — | — | — | −1.54 |
| fat, Palm - | — | — | — | — | — | — | — | — |
| STHF (Bunge | | | | | | | | |
| Loders | | | | | | | | |
| Croklaan) | | | | | | | | |
| Canola oil | — | 14.10 | 10 | 90.1 | 10.0 | — | — | — |
| Erythritol | 6.0 | — | 1.7 | — | — | — | — | −0.75 |
| water | — | 12.80 | 9.1 | — | — | — | — | — |
| moisture | — | (16.30) | (11.6) | — | — | — | — | — |
| bakeoff | | | | | | | | |
| four | — | 51.90 | 36.8 | 125.3 | 0.5 | 0.2 | 1.0 | — |
| Native wheat | — | 3.4 | 2.4 | 8.5 | 0.0 | — | 0.0 | — |
| starch (Aytex ® | | | | | | | | |
| P) | | | | | | | | |
| Cocoa butter | 8.0 | — | 2.3 | 20.9 | 2.3 | — | — | — |
| (Barry | | | | | | | | |
| Callebaut) | | | | | | | | |
| Defatted cocoa | 2.5 | — | 0.7 | 1.7 | 0.0 | 0.0 | 0.3 | |
| powder | | | | | | | | |
| (Bensdorp) | | | | | | | | |
| salt | — | 0.41 | 0.3 | — | — | — | — | — |
| Potassium | — | 0.37 | 0.3 | — | — | — | — | — |
| Bicarbonate | | | | | | | | |
| Sodium | — | 0.25 | 0.2 | — | — | — | | |
| Bicarbonate | | | | | | | | |
| Ammonium | — | 0.28 | 0.2 | — | — | — | — | — |
| Bicarbonate | | | | | | | | |
| Lecithin | 1.0 | 0.34 | 0.5 | 3.8 | 0.4 | 0.0 | — | — |
| Flavor | — | 0.05 | 0.0 | 0.0 | — | — | — | — |
| Cocoa liquor | 32.0 | — | 9.3 | 47.3 | 5.0 | 0.0 | 1.7 | — |
| (Barry | | | | | | | | |
| Callebaut) | | | | | | | | |
| PGPR | 0.50 | — | 0.1 | 1.3 | 0.1 | — | — | — |
| soluble corn | 10.0 | 2.5 | 4.7 | 10.3 | — | 0.1 | 3.8 | — |
| fiber | | | | | | | | |
| (Promitor@ 85) | | | | | | | | |
| Total | 29.0 | 71.0 | 100 | 385.7 | 18.9 | 0.5 | 8.1 | −2.3 |

TABLE 12
Baked product nutritional information for Example 6.

per 100 g product

| | | |
|---|---|---|
| Discrete confectionery component | 26.0 | g |
| Energy | 1612.1 | kJ |
| Fat | 18.9 | g |
| Sugars | 0.5 | g |
| Fiber (TDF) | 8.1 | g |
| Sugar alcohols | 29.7 | g |
| Carbs with energy content below 0.5 | 1.7 | g |
| kcal/g (erythritol, allulose, etc.) | | |
| Heat of solution of sugar alcohols + | −2.3 | J/g |
| Carbs with energy content below 0.5 | | |
| kcal/g (erythritol, allulose, etc.) | | |

1. A baked product having an energy content of no more than 1670 KJ per 100 g, the product comprising:
1.0 to 20 g per 100 g total dietary fibre;
at least 16 g per 100 g total fat;
0.05 to 4.00 g per 100 g of one or more caloric sugars;
5 to 33 g per 100 g of one or more sugar alcohols;
no more than 12 g per 100 g of one or more carbohydrates having an energy content of below 0.5 kcal/gram; and
0.1 to 16 wt. % of total moisture by weight of the baked product;
wherein a combined total theoretical heat of solution of the one or more sugar alcohols and/or the one or more carbohydrates having energy content below 0.5 kcal/gram is not lower than −6 j/g.

2. A baked product according to claim 1, wherein the one or more sugar alcohols are selected from the group consisting of erythritol, maltitol, mannitol, sorbitol, xylitol, arabitol, sorbitol, glycerol, hydrogenated starch hydrosylates (HSH), isomalt, lactitol, and combinations thereof.

3. A baked product according to claim 1, wherein the one or more carbohydrates having an energy content of below 0.5 kcal/g are selected from the group consisting of erythritol and allulose and combinations thereof.

4. A baked product according to claim 1, wherein the total fat in the baked product is provided by one or more ingredients selected from the group consisting of canola oil, palm oil, high oleic canola oil, olive oil, ground nut (peanut) oil, almond oil, avocado oil, coffee oil, milk fat, cocoa butter or fraction or equivalents of cocoa butter, polyglycerol esters, glycerophospholipids, mono- and di-glycerides, sucrose monoesters, sorbitan esters, polyethoxylated glycols, agar, albumin, casein, glyceryl monostearate, gums, soaps, Irish moss, egg yolk, lecithin, fats from finely milled nuts and seeds in the form of nut and seed butter or paste, e.g., hazelnut paste, peanut butter, cashew butter, almond butter, sunflower seed butter, sesame seed paste (tahini), pumpkin seed butter, etc., and combinations thereof.

5. A baked product according to claim 1, wherein the caloric sugar is selected from the group consisting of glucose, fructose, galactose, sucrose, lactose, maltose, isomaltose, isomaltulose, trehalose, trehalulose and sugar hydrates (such as dextrose monohydrate, for example), and combinations thereof.

6. A baked product according to claim 1, wherein the total dietary fibre is provided by an ingredient selected from the group consisting of polydextrose, inulin, fructo-oligosaccharides, mannotriose, monotetraose, soy bean oligosaccharides, arabinogalactans, xylo-oligosaccharides, xylotriose, xylotertaose, arabinoxylan-oligosaccharides, arabinotriose, arabinotetraose, milk oligosaccharides, 2′-fucosyl lactose, lacto-n-neotetraose, glucan (i.e. glucose containing) oligosaccharides, isomalto-oligosaccharides, (soluble fibre fraction), celo-oligosaccharides (or cellodextrins), resistant dextrins (e.g, soluble corn fibre, soluble wheat fibre, soluble tpioca fibre), nigero-oligosaccharides, nigertriose, nigerotetraose, kojitriose, kojitetraose, dextrans, beta glucans, lichenan, isolichenan, brans, celluloses, hemicelluloses, lignins, resistant starches, flours, insoluble chicory root fibre, isolate plant fibres, cocoa powder, pecan shell fibre, maple fibre, cocoa pod husk fibre, agave pina fibre, and combinations thereof.

7. A baked product according to claim 1, wherein the baked product comprises one or more materials selected from the group comprising a biscuit, cookie, cake, doughnut, cracker, wafer, pretzel, cereal, pastry, tart, biscotti, short breads, or muffin.

8. A baked product according to claim 1, wherein the baked product comprises a confectionery component and a baked component.

9. A baked product according to claim 8, wherein the confectionery component is present in an amount of 20 to 50 g per 100 g of the baked product and the baked component is present in an amount of 50 to 80 g per 100 g of the baked product.

10. A baked product according claim 8, wherein the confectionery component comprises one or more sugar alcohols in an amount of from 10-80 g per 100 g of the confectionery component; and/or wherein the baked component comprises one or more sugar alcohols in an amount of from 1 to 40 g per 100 g of the baked component.

11. A baked product according to claim 8, wherein the confectionery component comprises one or more carbohydrates having an energy content of below 0.5 kcal/g in an amount of from 1 to 40 g per 100 g of the confectionery component; and/or wherein the baked component comprises one or more carbohydrates having an energy content of below 0.5 kcal/g in an amount of from 1 to 40 g per 100 g of the baked component.

12. A baked product according to claim 8, wherein the confectionery component has a theoretical heat of solution of less than 6 J/g.

13. A baked product according to claim 8, wherein the confectionery component comprises total fat in an amount of 10-40 g per 100 g of the confectionery components; and/or wherein the baked component comprises total fat in an amount of 0-30 g per 100 g.

14. A baked product according to claim 8, wherein the confectionery component comprises caloric sugars in an amount of less than 1 g per 100 g of the confectionery component; and/or wherein the baked component comprises caloric sugars in an amount of less than 1 g per 100 g of the baked component.

15. A baked product according to claim 8, wherein the confectionery component comprises total dietary fibre in an amount of form 1 to 30 g per 100 g of the confectionery component; and/or wherein the baked component may comprise total dietary fibre in an amount of from 1 to 20 g per 100 g of the baked component.

16. A baked product according to claim 8, wherein the confectionery component is one or more materials selected from the group comprising a cream, chocolate, hard candy, jelly candy, chewy candy, toffee, fudge, marshmallow, mousse, gel, fondant, jam, fudge, and combinations thereof.

17. A baked product according to claim 8, wherein the baked component is one or more materials selected from the group comprising a biscuit, cookie, cake, doughnut, cracker, wafer, pretzel, cereal, pastry, tart, biscotti, short breads, muffins, and combinations thereof.

18. A baked product according to claim 8, wherein the baked product comprises a baked component filled with a confectionery component.

19. A baked product according to claim 8, wherein the baked product comprises a confectionery component partially or fully surrounded by a confectionery component

20. A baked product according to claim 8, wherein the baked product comprises a baked component enrobed or coated with a confectionery component.

21. A baked product according to claim 8, wherein the baked product comprises a layer of a confectionery component and a layer of a baked component, optionally wherein the layer of baked component and confectionery component are alternating layers.

22. A baked product according to claim 8, wherein the baked product comprises a baked component and a plurality of confectionery components, optionally wherein the plurality of confectionery components are distributed throughout the baked component.

23. A method for preparing a baked product according to claim 1, the method comprising the steps of providing a baked component and providing a confectionery component and depositing the confectionery component into or onto the baked product.

24. A method according to claim 23, wherein the method comprises the step of depositing a layer of the confectionery component onto a layer of the baked component.

25. A method according to claim 23, wherein the method comprises the steps of providing a first baked component, a second baked component, and a confectionery component; depositing the confectionery component onto the first baked component; and depositing the second baked component onto the confectionery component.

26. A method according to claim 23, wherein the method comprises the step of providing a baked component and a confectionery component; and coating the baked component with the confectionery component.

27. A method according to claim 23, wherein the method comprises filling a baked component with a confectionery component.

28. A packaged baked product according to claim 1.
